(19) United States
(12) Patent Application Publication
(10) Pub. No.: US 2003/0227867 A1
(43) Pub. Date: Dec. 11, 2003

(54) M-ary ask OFDM

(76) Inventor: Fuqin Xiong, North Olmsted, OH (US)

Correspondence Address: CALFEE HALTER & GRISWOLD, LLP, 800 SUPERIOR AVENUE, SUITE 1400, CLEVELAND, OH, 44114, US

(21) Appl. No.: 10/454,106

(22) Filed: Jun. 4, 2003

Related U.S. Application Data
(60) Provisional application No. 60/386,843, filed on Jun. 7, 2002.

(51) Int. Cl. H04J 11/00

(52) U.S. Cl. 370/210; 375/279

(57) ABSTRACT

A coherent MASK-OFDM digital communication system that includes logics for modulating and demodulating digital signals to be communicated using M-ary amplitude shift keying (MASK) and orthogonal frequency division multiplexing (OFDM) is provided. This MASK-OFDM system can be implemented digitally by discrete cosine transform (DCT) and inverse discrete cosine transform (IDCT). The (I)DCT can be implemented, for example, by an (I)FCT.

It is emphasized that this abstract is provided to comply with the rules requiring an abstract that will allow a searcher or other reader to quickly ascertain the subject matter of the application. It is submitted with the understanding that it will not be used to interpret or limit the scope or meaning of the claims. 37 CFR 1.72(b).

### CROSS REFERENCE TO RELATED APPLICATION

This application claims priority to the U.S. Provisional Application No. 60/386,843, filed Jun. 7, 2002, titled Coherent M-ary Amplitude Shift Keying OFDM System, which is incorporated herein by reference.

### TECHNICAL FIELD

The methods, systems, and computer readable media described herein relate generally to digital communications and more specifically to digital communication systems and methods that employ M-ary amplitude shift keying (MASK) modulation and orthogonal frequency division multiplexing (OFDM).

### BACKGROUND

Characteristics of conventional systems like null-to-null bandwidth, symbol rate, bit error rate, highest null point in power spectral density (PSD), lowest null frequency, and so on are described to facilitate later comparison to the MASK-OFDM systems and methods described herein.

Digital communications systems and methods that more efficiently use bandwidth are desirable. Conventional digital communications employing quadrature amplitude modulation (QAM) OFDM or M-ary phase shift keying (MPSK) OFDM employ a minimum frequency separation of 1/T, where T is the symbol duration. The bandwidth for these systems is determined by the frequency separation. Prior Art FIG. 1 illustrates that the total null-to-null bandwidth of these conventional systems is:

$${BW}_{QP} = \frac{( N + 1 )}{T} , ( QAM \text{-} OFDM , MPSK \text{-} OFDM )$$

Similarly, digital communication systems and methods with improved bit error rate (BER) are desirable. The BER for conventional MPSK-OFDM and QAM-OFDM systems in an additive white Gaussian noise (AWGN) channel are:

$${P}_{b} \approx \frac{2}{k} Q ( \sqrt{\frac{2 {kE}_{b}}{{N}_{0}}} sin \frac{π}{M} ) , \begin{matrix} & ( MPSK )\end{matrix}$$

$${P}_{b} \approx \frac{4 ( \sqrt{M} - 1 )}{k \sqrt{M}} Q ( \sqrt{\frac{3 k}{( M - 1 )}} \frac{{E}_{b}}{{N}_{0}} ) , \begin{matrix} & ( QAM )\end{matrix}$$

where k=log₂M is the number of bits per symbol and where:

$$Q ( x ) = {\int }_{x}^{∞} \frac{1}{\sqrt{2 π}} {ⅇ}^{- \frac{{x}^{2}}{2}} ⅆ x .$$

Systems and methods that reduce spectral aliasing are desired. For QAM-OFDM or MPSK-OFDM the highest null point in its PSD is fₕ=N/T. The lowest null point frequency is f₁=−1/T. Thus, to avoid severe aliasing in the spectrum of the sampled modulated signal, the sampling frequency is:

$${f}_{s} \geq ( {f}_{h} - {f}_{l} ) = \frac{N + 1}{T} = \frac{( N + 1 ) {R}_{b}}{{log}_{2} M} \qquad ( QAM \text{-} OFDM , MPSK \text{-} OFDM )$$

where R_{b} is the bit rate of each channel. To further reduce aliasing, f, is typically chosen much higher than this. For example, fₛ is often chosen as 2N/T. If N is a power of 2, 2N samples in a symbol period can be conveniently and efficiently generated by a 2N-point Fast Fourier Transform (FFT) with radix-2 algorithm. In terms of bit rate R_{b}:

$${f}_{s} = \frac{2 N}{T} = \frac{2 {NR}_{b}}{{log}_{2} M} \qquad ( QAM \text{-} OFDM , MPSK \text{-} OFDM )$$

Reducing power requirements and/or consumption can improve digital communication systems and methods. Reductions are particularly poignant to battery based systems. Due to orthogonality between different subcarriers, the total power in an OFDM system is the sum of the powers of the subcarriers Pᵢ, where:

$${P}_{i} = \frac{1}{T} {\int }_{0}^{T} {[ {A}_{i} cos ( {ω}_{i} t + {φ}_{i} ) ]}^{2} ⅆ t = \frac{1}{2} {A}_{i}^{2}$$

where Aᵢ cos(ωᵢt+φᵢ) is the i^{th} subcarrier with amplitude Aᵢ, angular frequency ωᵢ, and initial phase φᵢ. From this it is inferred that the total average power equals the sum of the average powers of the subcarriers, as in:

$${P}_{avg ( OFDM )} = E \{ {P}_{total} \} = {\sum }_{i = 0}^{N - 1} E \{ {P}_{i} \} = {\sum }_{i = 0}^{N - 1} {P}_{avgi}$$

where E{x} represents the statistical expectation of x.

Let QO represent QAM-OFDM and let PO represent PSK-OFDM. Peak power occurs when the subcarriers have the same maximum amplitudes. For QAM, the maximum amplitude is A_{max(QAM)}=\sqrt{2}(\sqrt{M}−1) (the outermost point in the constellation, assuming QAM having a square constellation with amplitudes ±1, ±3, . . . ±(\sqrt{M}−1) for its I and Q channel components), the maximum OFDM envelope is A_{peak(QO)}=N\sqrt{2}(\sqrt{M}−1), and the peak power is P_{peak(QO)}=N²(\sqrt{M}−1)². The average power of the square QAM signal on a single subcarrier is P_{avg}=(⅓)(M−1)P₀, where P₀ is the power of the smallest signal. For the assumed amplitude assignment, P₀=½\sqrt{2}²=1. Thus the average power of the QAM-OFDM signal on N subcarriers is P_{avg(QO)}=(⅓)N(M−1), and the peak to average power ratio (PAPR) is:

$${PAPR}_{( QO )} = \frac{{P}_{peak ( QO )}}{{P}_{avg ( QO )}} = \frac{3 N ( \sqrt{M} - 1 )}{\sqrt{M} + 1}$$

For MPSK, the amplitudes AMPSK of all subcarriers are the same all the time. Thus, the maximum OFDM envelope is A_{peak(PO)}=NA_{MPSK}, the peak power is P_{peak(PO)}=½N²A²MPSK, and the average power is P_{avg(PO)}=(½)NA²_{MPSK}. Thus, the PAPR is:

$${PAPR}_{( QO )} = \frac{{P}_{peak ( PO )}}{{P}_{avg ( PO )}} = N$$

Reducing hardware and computational complexity simplifies digital communications systems and methods. Conventional QAM-OFDM and MPSK-OFDM are implemented with hardware and/or software that perform discrete Fourier transforms (DFT) and inverse discrete Fourier transforms (IDFT). MASK-OFDM has conventionally not been implemented with DFT and IDFT because the frequency separation is 1/(2T) instead of 1/T. Conventional QAM-OFDM and MPSK-OFDM may employ fast Fourier transform (FFT) and inverse FFT (IFFT), which employ complex number (e.g., real and imaginary components) operations. For an N-point FFT or IFFT, (N/2)log₂N complex number multiplications and Nlog₂N complex number additions are employed. An N-subcarrier QAM-OFDM or MPSK-OFDM requires a 2N-point IFFT/FFT, which requires N(log₂N+1) complex number multiplications and 2N(log₂N+1) complex additions.

OFDM receiving apparatus have been described that include processing a reference symbol that is an ASK-modulated pseudo-random number. In U.S. Pat. No. 6,169,751 titled “OFDM Receiving Apparatus”, filed Mar. 9, 1998 and issued Jan. 2, 2001, an OFDM receiving apparatus is described. The apparatus employs conventional QAM and FFT processing for data symbols. In one example, the OFDM receiving apparatus performs synchronization processes that include processing a reference symbol that is an ASK-modulated pseudo-random number. Note that this is ASK and not M-ary ASK and that the single character processed is a reference symbol and not a data signal.

### SUMMARY

The following presents a simplified summary of systems, methods, and computer readable media described herein to facilitate providing a basic understanding of these items. This summary is not an extensive overview and is not intended to identify key or critical elements of the systems, methods and so on or to delineate the scope of these items. This summary provides a conceptual introduction in a simplified form as a prelude to the more detailed description that is presented later.

Coherent MASK-OFDM data communication systems and methods are described. MASK-OFDM systems and methods facilitate employing 1/(2T) frequency separation as opposed to conventional 1/T frequency separation. This facilitates more efficiently utilizing bandwidth. By selectively widening the narrowed bandwidth possible through MASK-OFDM systems and methods, it is possible to achieve a BER equivalent to QAM-OFDM systems or better than MPSK-OFDM systems.

Coherent MASK-OFDM digital communication systems and methods can be implemented digitally using a discrete cosine transform (DCT) for modulation and an inverse DCT (IDCT) for demodulation. Digital DCT and IDCT can be implemented using real number operations as opposed to complex (real+imaginary) number operations, thereby reducing processing time and complexity. Therefore, less hardware is required to implement the coherent MASK-OFDM digital communication systems and methods than conventional systems. Once again this facilitates reducing power requirements. In one example, the DCT and IDCT can be implemented using a Fast Cosine Transform (FCT) and an inverse FCT (IFCT).

Certain illustrative example systems, methods, and computer readable media are described herein in connection with the following description and the annexed drawings. These examples are indicative, however, of but a few of the various ways in which the principles of the examples may be employed and thus are intended to be inclusive of equivalents. Other advantages and novel features may become apparent from the following detailed description when considered in conjunction with the drawings.

### BRIEF DESCRIPTION OF THE DRAWINGS

Prior Art FIG. 1 illustrates spectra of QAM/PSK-OFDM subcarriers with 1/T separation.

FIG. 2 illustrates spectra of MASK-OFDM subcarriers with 1/(2T) separation.

FIG. 3 illustrates BERs for MASK, MQAM and MPSK.

FIG. 4 illustrates MASK and OFDM employing DCT components.

FIG. 5 illustrates an example MASK-OFDM modulation system.

FIG. 6 illustrates an example MASK-OFDM modulation system.

FIG. 7 illustrates modulation system components.

FIG. 8 illustrates demodulation system components.

FIG. 9 illustrates an example MASK-OFDM demodulation system.

FIG. 10 illustrates an example MASK-OFDM demodulation system.

FIG. 11 illustrates a modulator/demodulator employing MASK-OFDM.

FIG. 12 illustrates a method for modulating and multiplexing data.

FIG. 13 illustrates a method for demultiplexing and demodulating data.

FIG. 14 is a schematic block diagram of an example computing environment with which the systems and methods described herein can interact.

FIG. 15 illustrates 8ASK and 64QAM constellations.

### DETAILED DESCRIPTION

Example methods, systems, and computer media are now described with reference to the drawings, where like reference numerals are used to refer to like elements throughout. In the following description for purposes of explanation, numerous specific details are set forth in order to facilitate thoroughly understanding the examples. It may be evident, however, that the examples can be practiced without these specific details. In other instances, well-known structures and devices are shown in block diagram form in order to simplify description.

As used in this application, the term “digital communication component” refers to a digital communication related entity, either hardware, firmware, software, a combination thereof, or software in execution. For example, a digital communication component can be, but is not limited to being, a process running on a processor, a processor, an object, an executable, a thread of execution, a program, a device, a subsystem, an integrated circuit, an electronic device, and a computer. By way of illustration, both an application running on a server and the server can be digital communication components. One or more digital communication components can reside within a process and/or thread of execution and a digital communication component can be localized and/or distributed between two or more physical devices.

“Data store”, as used herein, refers to a physical and/or logical entity that can store data. A data store may be, for example, a database, a table, a file, a list, a queue, a heap, a register, a memory, and so on. A data store may reside in one logical and/or physical entity and/or may be distributed between two or more logical and/or physical entities.

“Signal”, as used herein, includes but is not limited to one or more electrical or optical signals, analog or digital, one or more computer instructions, a bit or bit stream, or the like.

“Software”, as used herein, includes but is not limited to, one or more computer readable and/or executable instructions that cause a computer, digital communication component, or other electronic device to perform functions, actions and/or behave in a desired manner. The instructions may be embodied in various forms like routines, algorithms, modules, methods, threads, and/or programs. Software may also be implemented in a variety of executable and/or loadable forms including, but not limited to, a stand-alone program, a function call (local and/or remote), a servelet, an applet, instructions stored in a memory, part of an operating system or browser, and the like. It is to be appreciated that the computer readable and/or executable instructions can be located in one digital communication component, one computer, and/or distributed between two or more communicating, co-operating, and/or parallel processing digital communication components and computers and thus can be loaded and/or executed in serial, parallel, massively parallel and other manners.

“Logic”, as used herein, includes but is not limited to hardware, firmware, software and/or combinations of each to perform function(s) or action(s). For example, based on a desired application or needs, logic may include a software controlled microprocessor, discrete logic such as an application specific integrated circuit (ASIC), or other programmed logic device. Logic may also be fully embodied as software. Where multiple logical logics are described, it may be possible to incorporate the multiple logical logics into one physical logic. Similarly, where a single logical logic is described, it may be possible to distribute that single logical logic between multiple physical logics.

Some portions of the detailed descriptions that follow are presented in terms of algorithms and symbolic representations of operations on data bits within a digital communication component and/or computer memory. These algorithmic descriptions and representations are the means used by those skilled in the data processing arts to convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated.

It has proven convenient at times, principally for reasons of common usage, to refer to these signals as bits, values, elements, symbols, characters, terms, numbers, or the like. It should be borne in mind, however, that these and similar terms are to be associated with the appropriate physical quantities and are merely convenient labels applied to these quantities. Unless specifically stated otherwise as apparent from the following discussions, it is appreciated that throughout the description, discussions utilizing terms like processing, computing, calculating, determining, displaying, or the like, refer to the action and processes of a computer system, computer component, or similar electronic computing device, that manipulates and transforms data represented as physical (electronic) quantities within the computer system's registers and memories into other data similarly represented as physical quantities within the computer system memories or registers or other information storage, transmission or display devices.

It will be appreciated that some or all of the processes and methods of the system involve electronic and/or software applications that may be dynamic and flexible processes so that they may be performed in sequences different than those described herein. It will also be appreciated by one of ordinary skill in the art that elements embodied as software may be implemented using various programming approaches such as machine language, procedural, object oriented, and/or artificial intelligence techniques.

The processing, analyses, and/or other functions described herein may also be implemented by functionally equivalent circuits like a digital signal processor (DSP), a software controlled microprocessor, or an ASIC. Components implemented as software are not limited to any particular programming language. Rather, the description herein provides the information one skilled in the art may use to fabricate circuits or to generate computer software and/or computer components to perform the processing of the system. It will be appreciated that some or all of the functions and/or behaviors of the present system and method may be implemented as logic as defined above.

In one example, multiple subcarriers with frequencies different by half of the symbol rate are modulated by data symbols using coherent M-ary amplitude shift keying in a modulator in a transmitter. The resultant modulated multiple carriers are summed to form an orthogonal frequency division multiplexed signal. In one example, an FCT is employed to digitally implement the DCT employed in MASK-OFDM modulation.

Modulated multiple carriers are separated and demodulated in a receiver by a demodulator. In one example, an IFCT is employed to digitally implement the IDCT employed in MASK-OFDM demodulation. The MASK-OFDM modulation and demodulation facilitate communication systems, wired or wireless, communicating at similar or improved bit error rates with substantially the same bandwidth and reduced system and computational complexity compared to conventional QAM-OFDM and MPSK-OFDM systems.

Bandwidth is a precious commodity. Conventional digital communications systems and methods employing QAM OFDM or MPSK OFDM employ a minimum frequency separation of 1/T, where T is the symbol duration. The bandwidth for these systems is therefore determined by the frequency separation. Prior Art FIG. 1 illustrates that the total null-to-null bandwidth of such conventional systems is:

$${BW}_{QP} = \frac{( N + 1 )}{T} , ( QAM \text{-} OFDM , MPSK \text{-} OFDM )$$

In Prior Art FIG. 1, different carrier frequencies (e.g., 100, 110, 120, 130) are separated by 1/T, for a total bandwidth of N/T, where N is the number of subcarrier frequencies. Coherent MASK-OFDM systems and methods employ subcarriers that differ only in frequency and amplitude. If the phases for the subcarriers are the same (0, π/2, π) then the minimum frequency spacing can be reduced to 1/(2T) while maintaining orthogonality.

OFDM has gained widespread use in digital communications due to its high bandwidth efficiency. OFDM uses multiple orthogonal subcarriers with overlapped spectra at transmission. The spectral overlapping conserves bandwidth while the orthogonality between subcarriers facilitates separating the signals on the subcarriers at the receiver.

The OFDM signal has the general form:

$$v ( t ) = {\sum }_{i = 0}^{N - 1} {A}_{i} cos ( {ω}_{i} t + {φ}_{i} )$$

where Aᵢ, ωᵢ=2 πfᵢ, and φᵢ are the amplitude, angular frequency, and phase of the ith subcarrier. N is the number of subcarriers. If the signal is amplitude shift keyed (ASK), Aᵢ is determined by the data and φᵢ is an initial phase that is usually assumed to be zero. If the signal is phase shift keyed (PSK), Aᵢ is a constant and φᵢ is determined by the data. If the signal is quadrature amplitude modulated (QAM), both Aᵢ and φᵢ are determined by the data. PSK and QAM are conventionally used with OFDM. These methods require a minimum 1/T frequency separation between subcarriers for orthogonality, T being the symbol duration. For fᵢ being an integer multiple of 1/(2T), and fᵢ and fⱼ being separated by 1/T:

$${\int }_{0}^{T} {A}_{i} {A}_{j} cos ( {ω}_{i} t + {φ}_{i} ) cos ( {ω}_{j} t + {φ}_{j} ) ⅆ t = 0 , \begin{matrix} & i \neq j\end{matrix}$$

and is nonzero otherwise.

However, for orthogonality, the minimum frequency separation of a coherent M-ary ASK-OFDM system is only 1/(2T). Thus, a MASK-OFDM signal can be written:

$$v ( t ) = {\sum }_{i = 0}^{N - 1} {A}_{i} cos {ω}_{i} t$$

In the above expression, the phase id is zero for the subcarriers. This facilitates employing a 1/(2T) minimum separation for orthogonality since:

$${\int }_{0}^{T} {A}_{i} {A}_{j} cos {ω}_{i} t cos {ω}_{j} t ⅆ t = 0 , \begin{matrix} & i \neq j\end{matrix}$$

and is nonzero otherwise, for fᵢ being an integer multiple of 1/(2T) and fᵢ and fⱼ being separated by 1/(2T). Other forms of MASK-OFDM can include:

$$\begin{matrix}v ( t ) = {\sum }_{i = 0}^{N - 1} {A}_{i} cos ( {ω}_{i} t + π / 2 ) and \\ v ( t ) = {\sum }_{i = 0}^{N - 1} {A}_{i} cos ( {ω}_{i} t + π )\end{matrix}$$

with fᵢ being an integer multiple of 1/(2T) and fᵢ being separated by 1/(2T).

Therefore, in one example, a coherent MASK-OFDM signal is:

$$s ( t ) = {\sum }_{k = 0}^{N - 1} {A}_{k} cos 2 π \frac{k}{2 T} t$$

where Aₖ is one of the M-ary amplitudes. Each subcarrier frequency fₖ=k/(2T), where the k are contiguous integers. Thus, the frequency separation is 1/(2T).

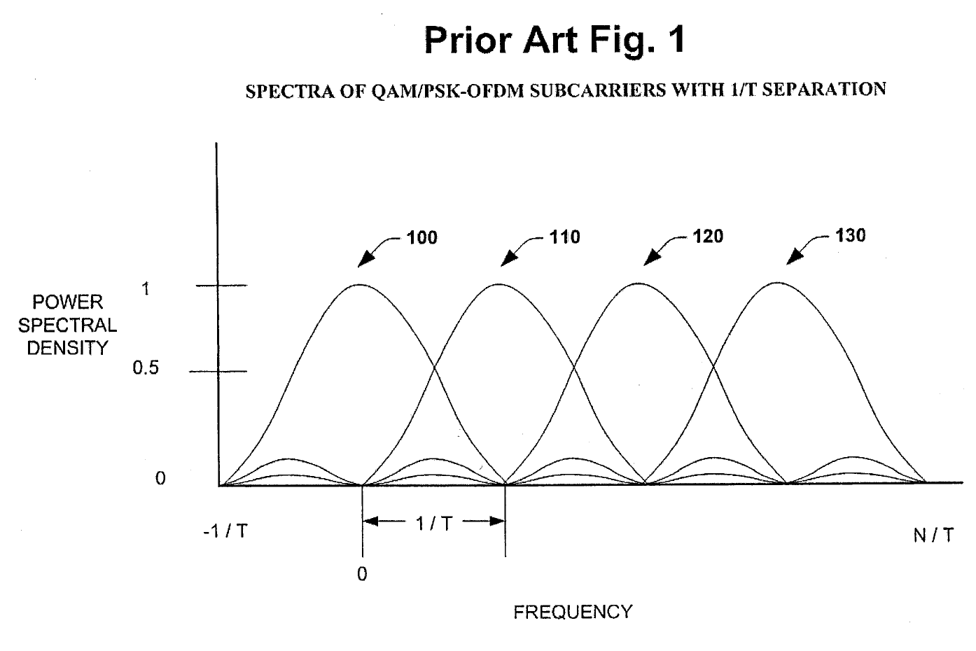

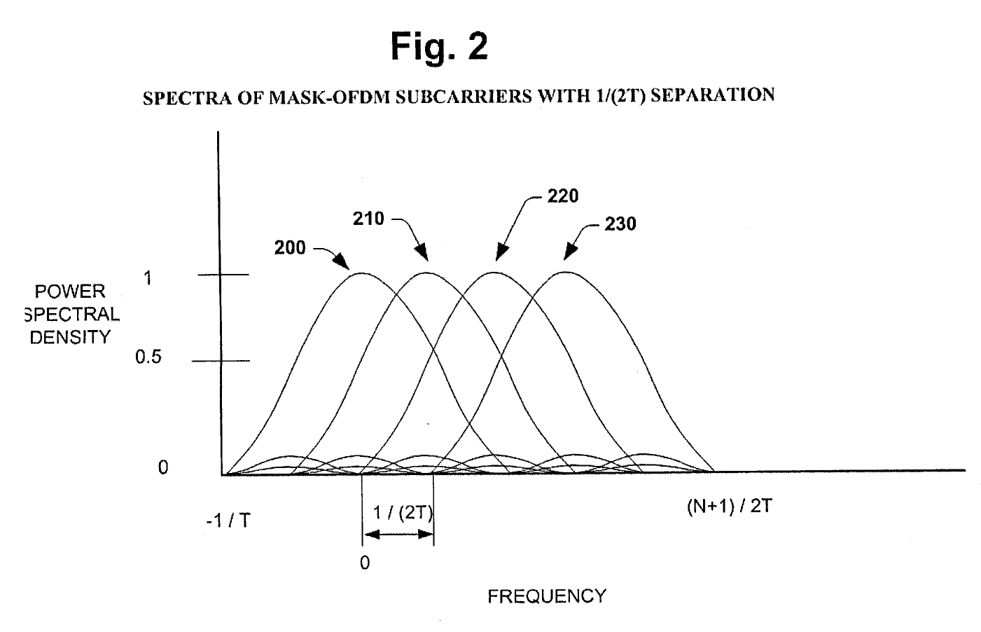

In FIG. 2, different carrier frequencies (e.g., 200, 210, 220, 230) are separated by 1/(2T), for a total bandwidth of (N+3)/(2T), which is less than that required in Prior Art FIG. 1.

The signal orthogonality is verified by the following integration:

$${\int }_{0}^{T} {A}_{i} {A}_{j} cos 2 π \frac{i}{2 T} t cos 2 π \frac{j}{2 T} t ⅆ t = 0 , \qquad i \neq j$$

Prior Art FIG. 1 illustrates the spectra of four channel OFDM systems with 1/T spacing. FIG. 2 illustrates the spectra of four channel OFDM systems with 1/(2T) spacing. Prior Art FIG. 1 illustrates that the total null to null bandwidth of QAM-OFDM and MPSK-OFDM is:

$${BW}_{QP} = \frac{( N + 1 )}{T} \qquad ( QAM \text{-} OFDM , MPSK \text{-} OFDM )$$

Similarly, FIG. 2 illustrates that the total null to null bandwidth for MASK-OFDM is:

$${BW}_{A} = \frac{( N + 3 )}{2 T} \qquad ( MASK \text{-} OFDM )$$

Thus, MASK-OFDM illustrates a bandwidth savings over QAM-OFDM or MPSK-OFDM of:

BW_{savings}=2(N+1)/(N+3), which approaches 2 when N goes to infinity.

In some examples, for the same modulation order M, coherent MASK may have less power efficiency than coherent MPSK or QAM. Thus, in one example, bandwidth savings can be traded for power efficiency. For an approximately fixed bandwidth occupancy, when coherent MASK is employed for OFDM, the number of bits per symbol can be halved. The halving is possible because of the half subcarrier frequency spacing compared to MPSK or QAM. For example, M can be reduced to \sqrt{M} which recovers the power efficiency.

By way of illustration, consider QAM with amplitudes of ±1, ±3, . . . , ±(\sqrt{M}−1) on both I and Q channels, and consider amplitudes of the MASK at ±1, ±3, . . . ±1 (M−1). Then the BER expressions for MASK and QAM for coherent receivers in an AWGN channel are:

$$\begin{matrix}\begin{matrix}{P}_{b} = \frac{2 ( M - 1 )}{kM} Q ( \sqrt{\frac{6 k}{{( {M}^{2} - 1 )}_{0}} \frac{{E}_{b}}{{N}_{0}} )} ) , & & ( MASK )\end{matrix} & ( Equation 1 ) \\ \begin{matrix}{P}_{b} = \frac{4 ( \sqrt{M} - 1 )}{k \sqrt{M}} Q ( \sqrt{\frac{3 k}{{( M - 1 )}_{0}} \frac{{E}_{b}}{{N}_{0}} )} ) , & & ( QAM )\end{matrix} & ( Equation 2 )\end{matrix}$$

Substituting M with \sqrt{M} and k with k/2 in Equation 1 yields Equation 2. This illustrates that reducing the order of M in MASK to \sqrt{M} produces the same power efficiency as that of QAM. Similarly, reducing the order of M in MASK to \sqrt{M} produces an improved power efficiency over MPSK. The MPSK BER for a coherent receiver in an AWGN channel is:

$${P}_{b} \approx \frac{2}{k} Q ( \sqrt{\frac{2 {kE}_{b}}{{N}_{0}}} sin \frac{π}{M} ) \qquad ( MPSK )$$

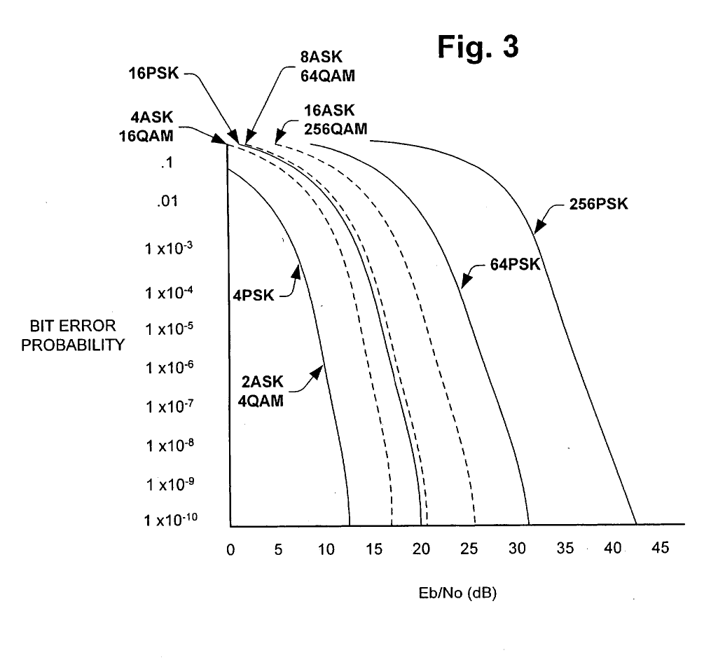

FIG. 3 compares MASK, MPSK and QAM on BER performance. Note that reducing the MASK order to \sqrt{M} leads to 0, 4, 10, and 16 dB power efficiency improvements compared to 4, 16, 64 and 256 PSK respectively.

The symbol rate (R_{S}) for MASK-OFDM is twice that of conventional QAM-OFDM since log₂M=2log₂\sqrt{M}. Thus, the bandwidth ratio of MASK over QAM or PSK becomes:

$$BWR = \frac{N + 3}{N + 1} = 1 + \frac{2}{N + 1}$$

For N=8, the bandwidth increase is about 22%. When N becomes very large (e.g., N=256) BWR increase is negligible (e.g., BWR=1.008).

In digital implementations, sampling frequency influences aliasing. For QAM-OFDM or MPSK-OFDM the highest null point in its PSD is fₕ=N/T. The lowest null point frequency is f₁=−1/T. Thus, to avoid severe aliasing in the sampled modulated signal spectrum, a good sampling frequency is:

$${f}_{s} \geq ( {f}_{h} - {f}_{l} ) = \frac{N + 1}{T} = \frac{( N + 1 ) {R}_{b}}{{log}_{2} M} \qquad ( QAM \text{-} OFDM , MPSK \text{-} OFDM )$$

where R_{b} is the bit rate of each channel. To further reduce aliasing, fₛ is typically chosen higher than this. For example, fₛ is typically chosen as 2N/T. If N is a power of 2, 2N samples in a symbol period can be generated by a 2N-point FFT with radix-2 algorithm. In terms of bit rate R_{b}:

$${f}_{s} = \frac{2 N}{T} = \begin{matrix}\frac{2 {NR}_{b}}{{log}_{2} M} & & ( QAM \text{-} OFDM , MPSK \text{-} OFDM )\end{matrix}$$

Compare this to M-ary ASK OFDM. For MASK-OFDM, the highest null point in its PSD is fₕ=(N+1)/(2T). The lowest null point frequency is f₁=−1/T. To avoid aliasing in the sampled modulated signal spectrum, an example sampling frequency is:

$${f}_{s} \geq ( \frac{N + 3}{2 T} )$$

For N≧3, which is satisfied in practical OFDM systems,

$$\frac{N + 3}{2 T} \leq \frac{N}{T}$$

Thus, the sampling frequency for a \sqrt{M}-ary ASK-OFDM can be selected as:

$${f}_{s} = \frac{N}{T} = \frac{{NR}_{b}}{{log}_{2} \sqrt{M}} = \frac{2 {NR}_{b}}{{log}_{2} M} \qquad ( \sqrt{M} \text{-} ary ASK \text{-} OFDM )$$

For MASK-OFDM, using fₛ=N/T instead of fₛ=(N+3)/(2T), for big N the sampling frequency approximately doubles what was required, similar to QAM-OFDM and MPSK-OFDM. However, the complexity of a digital implementation of MASK-OFDM compared to the complexity of an implementation of QAM-OFDM or MPSK-OFDM is reduced since the samples per symbol is N for MASK-OFDM instead of 2N as for QAM-OFDM or MPSK-OFDM.

The example \sqrt{M}-ary ASK-OFDM systems and methods described herein facilitate reducing power requirements. Thus, for mobile devices, extended battery life is possible. Also, for some systems, reduced power requirements facilitate heat dissipation and increased miniaturization.

Orthogonality between different subcarriers in an OFDM system yields a total power that is the sum of the powers of the subcarriers Pᵢ, where:

$${P}_{i} = \frac{1}{T} {\int }_{0}^{T} {[ {A}_{i} cos ( {ω}_{i} t + {φ}_{i} ) ]}^{2} ⅆ t = \frac{1}{2} {A}_{i}^{2}$$

Thus, the total average power equals the sum of the average powers of the subcarriers as in:

$${P}_{avg ( OFDM )} = E \{ {P}_{total} \} = {\sum }_{i = 0}^{N - 1} E \{ {P}_{i} \} = {\sum }_{i = 0}^{N - 1} {P}_{avgi}$$

where E{x} denotes the statistical expectation of x.

Let AO represent MASK-OFDM, QO represent QAM-OFDM and PO represent PSK-OFDM. The average power of an equal amplitude spaced bipolar MASK signal on a subcarrier is:

$${P}_{( avg )} = \frac{1}{3 T} ( {M}^{2} - 1 ) {A}_{0}^{2}$$

where A₀ is the smallest amplitude on a normalized cosine (or sine) signal (e.g., \sqrt{2/T} cos(ωt)). For the amplitude assignment described above, A₀=\sqrt{2/T} and the average power of the OFDM signal on N subcarriers is:

$${P}_{avg ( AO )} = \frac{1}{6} N ( {M}^{2} - 1 ) ( 0 , π , π / 2 )$$

Peak power is defined as the power of a sine (or cosine) wave with an amplitude equal to the maximum envelope value. Peak power occurs when the subcarriers have the same maximum amplitudes A_{max(MASK)}=(M−1) and the same phase (0, π/2, π). Thus, the maximum envelope of the MASK-OFDM signal is equal to A_{peak(AO)}=N(M−1). Thus, the peak to average power ratio (PAPR) is:

$${PAPR}_{( AO )} = \frac{{P}_{peak ( AO )}}{{P}_{avg ( AO )}} = 3 N \frac{M - 1}{M + 1}$$

For QAM, the maximum amplitude is A_{max(QAM)}=\sqrt{2}(\sqrt{M}−1) (the outermost point in the constellation), the maximum OFDM envelope is A_{peak(QO)}=N\sqrt{2}(\sqrt{M}−1), and the peak power is P_{peak(QO)}=N²(\sqrt{M}−1)². The average power of the square QAM signal on a single subcarrier is P_{avg=}⅓(M−1)P₀, where P₀ is the power of the smallest signal. For the assumed amplitude assignment, P₀=½\sqrt{2}²=1. Thus the average power of the QAM-OFDM signal on N subcarriers is P_{avg(QO)}=⅓N(M−1), and the PAPR is:

$${PAPR}_{( QO )} = \frac{{P}_{peak ( QO )}}{{P}_{avg ( QO )}} = \frac{3 N ( \sqrt{M} - 1 )}{\sqrt{M} + 1}$$

For MPSK, the amplitudes are the same, A_{MPSK}. Thus, the maximum OFDM envelope is A_{peak(PO)}=NA_{MPSK}, and the peak power is P_{peak(PO)}=½N²A² _{MPSK}. The average power of the MPSK-OFDM signal on N subcarriers is P_{avg(PO)}=½NA²_{MPSK}. Thus, the PAPR is:

$${PAPR}_{( PO )} = \frac{{P}_{peak ( PO )}}{{P}_{avg ( PO )}} = N$$

Thus, the PAPR of the MASK-OFDM is increased over QAM by a factor of:

$$\frac{ ( {\sqrt{M - 1}}^{2} )}{M + 1}$$

Similarly, the PAPR of the MASK-OFDM is increased over MPSK by a factor of:

$$3 \frac{( M - 1 )}{M + 1}$$

Thus, the \sqrt{M}-ary ASK OFDM systems and methods described herein achieve similar PAPR as MQAM-OFDM. Power efficiency losses can be recovered by reducing order M to \sqrt{M}. Furthermore, when compared with MPSK-OFDM, the MASK-OFDM systems and methods described herein increase PAPR while improving overall power efficiency.

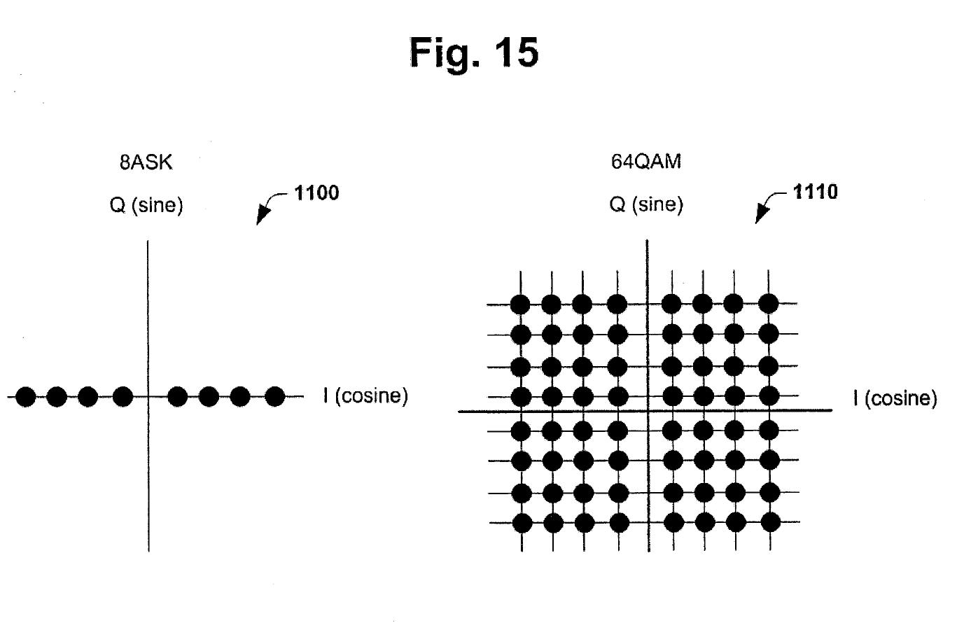

Hardware and computational complexity are directly related to dollar and time cost for data communications systems and methods. Conventional QAM-OFDM and MPSK-OFDM are implemented with inverse discrete Fourier transform (IDFT). This implementation is hardware and computationally complex compared to MASK-OFDM. The system complexity is reduced since MASK is a one-dimensional modulation while QAM and PSK are two-dimensional modulations (see, for example, FIG. 15).

Conventional QAM-OFDM and MPSK-OFDM may employ FFT and IFFT, which employ complex number (e.g., real and imaginary components) operations. For an N-point FFT or IFFT, (N/2)log₂N complex number multiplications and Nlog₂N complex number additions are employed. An N-subcarrier QAM-OFDM or MPSK-OFDM requires a 2N-point IFFT/FFT, which requires N(log₂N+1) complex number multiplications and 2N(log₂N+1) complex additions.

The MASK-OFDM systems and methods described herein can employ a DCT and an IDCT. DCT and IDCT are a pair of orthogonal transforms that can be employed for modulating and demodulating MASK-OFDM signals. The DCT and IDCT can be implemented digitally and can manipulate real numbers instead of complex numbers as are used in FFT/IFFT implementations. This facilitates reducing hardware and computational complexity. In one example, the DCT and IDCT are implemented using an FCT and an IFCT. The FCT is a fast algorithm for implementing DCT.

An example DCT/IDCT pair are:

$$\begin{matrix}X ( n ) = \frac{2}{N} ϵ ( n ) {\sum }_{k = 0}^{N - 1} x ( k ) cos \frac{π n ( 2 k + 1 )}{2 N} , n = 0 , 1 , … , N - 1 & ( DCT ) \\ X ( k ) = {\sum }_{n == 0}^{N - 1} ϵ ( n ) X ( n ) cos \frac{π n ( 2 k + 1 )}{2 N} , k = 0 , 1 , … , N - 1 & ( IDCT ) \\ where ϵ ( n ) = \{ \begin{matrix}\frac{1}{\sqrt{2}} , & n = 0 \\ 1 , & otherwise\end{matrix} & \end{matrix}$$

In one example, to write the MASK-OFDM signal in the form of the DCT, first let t=n·Δt and T=N·Δt in the continuous time MASK-OFDM signal expression.

$$s ( t ) = {\sum }_{k = 0}^{N - 1} {A}_{k} cos 2 π \frac{k}{2 T} t$$

This converts the MASK-OFDM into discrete time form:

$$s ( n ) = {\sum }_{k = 0}^{N - 1} {A}_{k} cos \frac{π n ( 2 k )}{2 N}$$

To employ the DCT, a frequency shift of 1/(4T) is introduced to each subcarrier. Therefore, redefine the MASK-OFDM signal as:

$$\begin{matrix}S ( t ) = ϵ ( t ) {\sum }_{k = 0}^{N - 1} {A}_{k} cos \frac{π ( 2 k + 1 ) t}{2 T} \\ where ϵ ( t ) = \{ \begin{matrix}\frac{1}{\sqrt{2}} , 0 \leq t \leq Δ t \\ 1 , Δ t \leq t \leq T\end{matrix}\end{matrix}$$

Using this redefinition and frequency shift, the subearrier frequencies become 1/(4T), 3/(4T), 5/(4T), . . . (2N−1)/(4T). These subcarrier frequencies are still 1/(2T), but the total signal bandwidth has been shifted up by 1/(4T). A discrete form of the redefined MASK-OFDM signal is:

$$s ( n ) = \frac{2}{N} ϵ ( n ) {\sum }_{k = 0}^{N - 1} {A}_{k} cos \frac{π n ( 2 k + 1 )}{2 N} , n = 0 , 1 , … , N - 1$$

where 2/N is a constant. The discrete form employs a sampling frequency of N/T. MASK-OFDM in the form of

$$s ( t ) = ϵ ( t ) {\sum }_{k = 0}^{N - 1} {A}_{k} cos \frac{π ( 2 k + 1 ) t}{2 T}$$

can be generated by an N-point FCT using:

$$s ( n ) = \frac{2}{N} ϵ ( n ) {\sum }_{k = 0}^{N - 1} {A}_{k} cos \frac{π n ( 2 k + 1 )}{2 N} , n = 0 , 1 , … , N - 1$$

and can be demodulated using an N-point IFCT like:

$${A}_{k} = {\sum }_{n = 0}^{N - 1} ϵ ( n ) s ( n ) cos \frac{π n ( 2 k + 1 )}{2 N} , k = 0 , 1 , … , N - 1$$

One example algorithm for computing FCT/IFCT decomposes the N-point FCT or IFCT into two smaller N/2 point FCT or IFCT, and then decomposing further as desired. The example algorithm employs (N/2)log₂N real number multiplications and (3N/2)log₂N−N+1 real number additions. While the number of real number multiplications and additions for one example algorithm are described, it is to be appreciated that other FCT/IFCT algorithms may employ other mixes of real number multiplications, additions, and/or other operations.

Comparing these real number operations to conventional complex number operations facilitates understanding how the MASK-OFDM systems and methods described herein reduce hardware and/or computing complexity. Conventional QAM-OFDM and MPSK-OFDM may employ FFT and IFFT that employ complex number (e.g., real and imaginary components) operations. For an N-point FFT or IFFT, (N/2)log₂N complex number multiplications and Nlog₂N complex number additions are employed. An N-subcarrier QAM-OFDM or MPSK-OFDM requires a 2N-point IFFT/FFT, which requires N(log₂N+1) complex number multiplications and 2N(log₂N+1) complex additions. Thus, using the example algorithm, the number of multiplications and additions are reduced by about fifty percent. Furthermore, the type of operations are changed from complex number operations to real number operations, which can be implemented with less hardware and computing complexity.

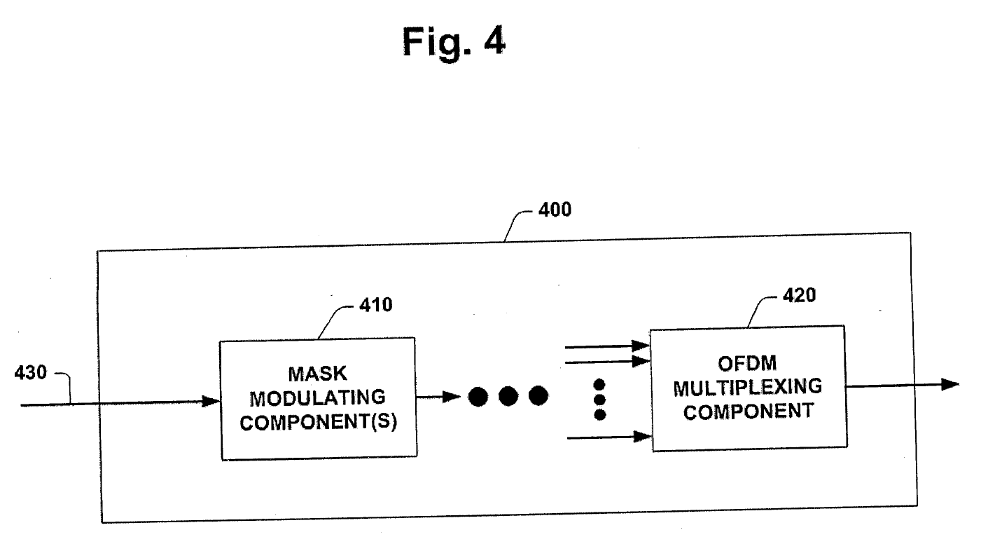

FIG. 4 illustrates a system 400 that includes a MASK modulating component 410 and an OFDM multiplexing component 420. The MASK modulating component 410 may be a logic that receives a digital signal 430 (e.g., data signal) to be transmitted. The digital signal 430 can be, for example, binary data bits. The binary data bits can be mapped, for example, through a MASK mapping device to symmetrical bipolar M-ary ASK symbols that are then modulated on N subcarriers. The subcarriers are separated in frequency by half the symbol rate for orthogonality between the subcarriers. Component 410 modulates the digital signal 430 into M amplitude shift keyed signals, M being an integer. Since the digital signal 430 has been modulated into multiple signals, it is possible to multiplex those signals. Thus, the system 400 includes OFDM component 420. OFDM component 420 may be a logic that orthogonally frequency division multiplexes the amplitude shift keyed signals. In one example, the OFDM component 420 may be an adder. In one example, the MASK modulating component 410 and the OFDM multiplexing component 420 employ an FCT to implement a DCT for modulating the digital signal 430. The FCT may be implemented digitally.

After the digital signal 430 has been modulated and multiplexed, system 400 may interact with a transmitter (not illustrated) to transmit the orthogonally frequency division multiplexed amplitude shift keyed signals. In one example, the transmitter may be a wireless transmitter (e.g., transmit signals over the air via RF). It is to be appreciated that the transmitter may also transmit over one or more wires, one or more fiber optic cables, and so on. Thus, the transmitter, and the system 400 can be employed in systems including, but not limited to, wireless, wired, mobile, and satellite based systems.

The MASK modulating component 410 is operably connected to the OFDM component 420. The connection may be direct and/or indirect. Thus, signals may flow from the MASK modulating component 410 to the OFDM component 420 via zero or more intermediate digital communication components, logics, processes, flows, and so on. While two logics are displayed in FIG. 4 it is to be appreciated that the logics can be combined and/or distributed into a greater and/or lesser number of logics.

In one example, the MASK modulating component 410 takes k=log₂M bits from an input binary data stream and maps the bits into an amplitude level Aᵢ, which is one of the MASK signal points in the MASK constellation (see, for example, FIG. 15). The mapping may be, for example, Gray coding so that k-tuples representing the adjacent amplitudes differ by one bit. The mapping can be performed digitally, for example, through a look-up table. A data store may store the look-up table of M amplitude values. The k bits can be used as an address to fetch the corresponding amplitude value. The output is a binary number representing the amplitude value. This example implementation facilitates the operation of the digital implementation of the FCT.

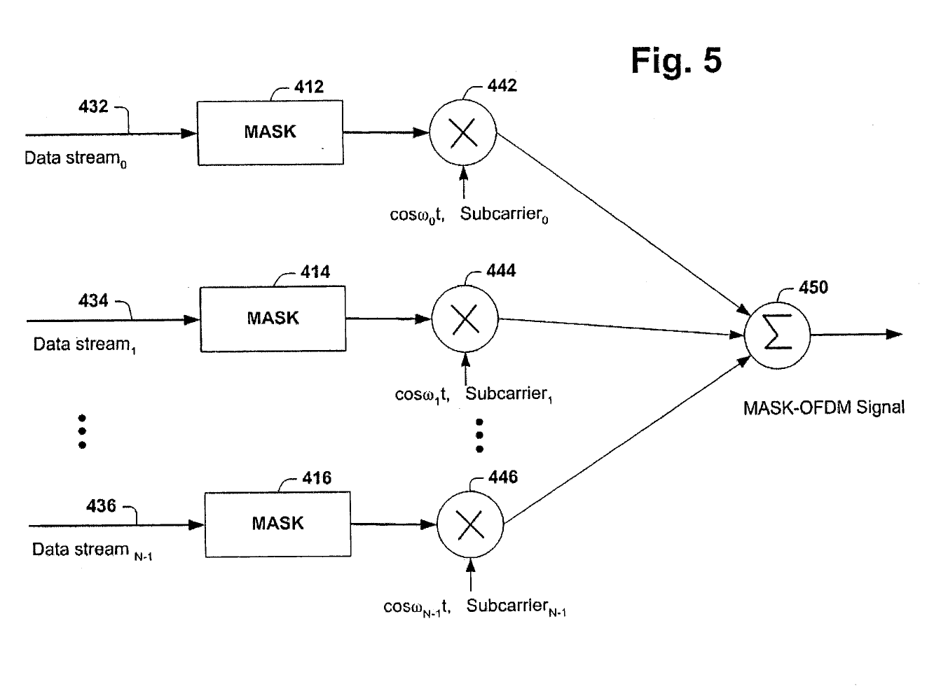

FIG. 5 illustrates an example MASK-OFDM system. The system accepts a plurality of data streams (e.g., data streams 432 through data stream_{N-1} 436). Each data stream is then modulated by using digital communication components like an M-ary ask modulator (e.g., MASK modulator 412 through MASK modulator 416) and multiipliers (e.g., multiupliers 442 through 446). The modulated signals are then multiplexed through a multiplexer 450. In one example, the multiplexer 450 may be an adder. FIG. 5 illustrates the modulating and the multiplexing broken out into separate logical functions.

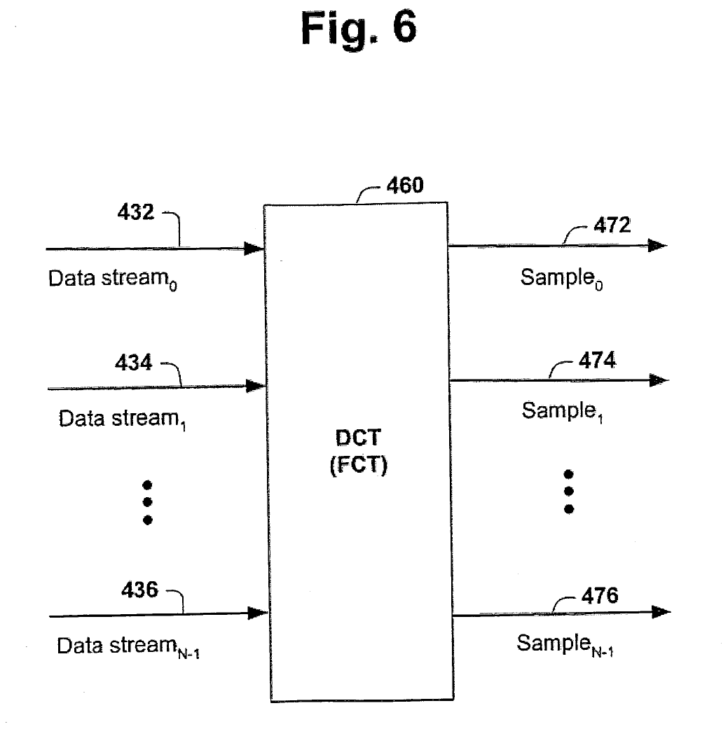

FIG. 6 illustrates a system in which the modulating and multiplexing are performed in a single logic 460 that implements a DCT. In one example, the DCT is implemented by an FCT. The logic 460 receives a plurality of data streams (e.g., data streams 432 through data stream_{N-1} 436). The data streams are then modulated and multiplexed and a plurality of samples of MASK-OFDM signals (e.g., samples 472 through sample_{N-1} 476) are produced.

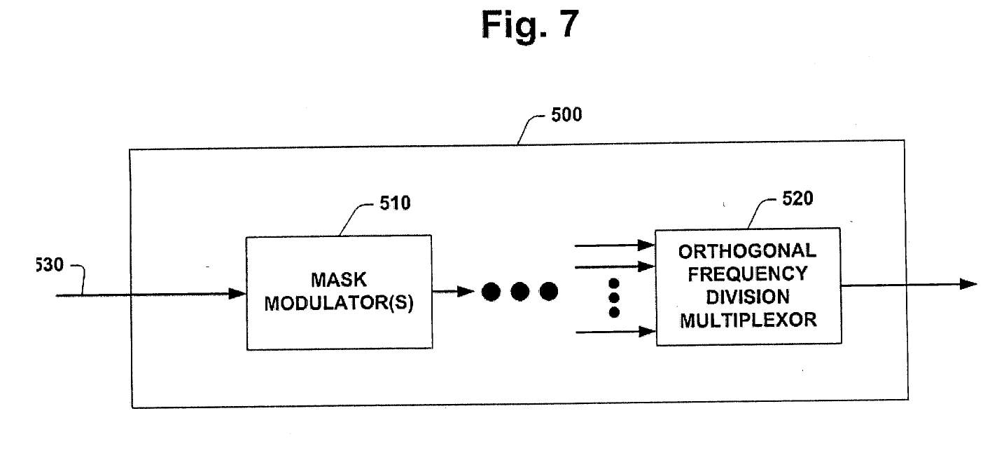

FIG. 7 illustrates a modulation system 500. The modulation system 500 includes an M-ary amplitude shift key modulator 510 that receives a digital signal 530 to transmit and that modulates the digital signal 530 via amplitude shift keying into M amplitude shift keyed signals, M being an integer. The modulation system 500 also includes an orthogonal frequency division multiplexer 520 that frequency division multiplexes the amplitude shift key modulated signals.

The system 500 may include and/or interact with a transmitter (not shown) that transmits the frequency division multiplexed amplitude shift keyed signals. In one example, the modulator 510 and multiplexer 520 employ an FCT to implement a DCT for modulating the digital signal 530 into the amplitude shift keyed signals. The FCT can be implemented digitally, for example.

The modulator 510 is operably connected to the multiplexer 520. The connection may be direct and/or indirect. Thus, signals may flow from the modulator 510 to the multiplexer 520 via zero or more intermediate digital communication components, logics, processes, flows, and so on. While two logics are displayed in FIG. 5 it is to be appreciated that the logics can be combined and/or distributed into a greater and/or lesser number of logics.

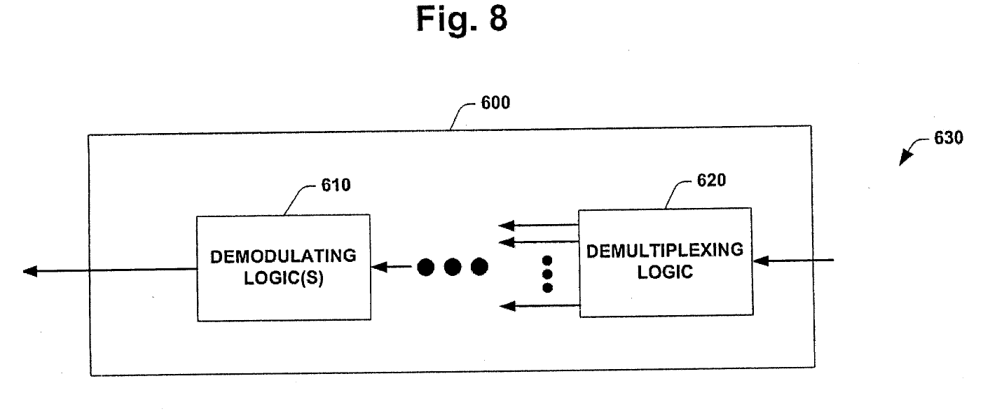

FIG. 8 illustrates a system 600 that demodulates an orthogonally frequency division multiplexed signal. The system 600 includes a logic 620 that demultiplexes an orthogonally frequency division multiplexed signal 630 into M amplitude shift keyed signals. The system 600 also includes a logic 610 that demodulates the amplitude shift keyed signals into a digital signal. The digital signal may then be passed to other digital communication components.

In one example, the system 600 includes and/or interacts with a receiver (not shown) that receives the orthogonally frequency division multiplexed signal 630. The orthogonally frequency division multiplexed signal 630 may be carried, for example, on carrier frequencies that are separated by 1/(2T). In one example, the receiver may be a wireless receiver (e.g., receive signals over the air via RF). It is to be appreciated that the receiver may also receive signals over one or more wires, one or more fiber optic cables, and so on. Thus, the receiver, and the system 600 can be employed in systems including, but not limited to, wireless, wired, mobile, and satellite based systems.

In one example, the demodulating logic 610 employs an IFCT to perform an IDCT employed in demodulating. The IFCT can be implemented digitally, for example. The demodulating logic 610 is operably connected to the demultiplexing logic 620. The connection may be direct and/or indirect. Thus, signals may flow from the demultiplexing logic 620 to the demodulating logic 610 via zero or more intermediate computer components, logics, processes, flows, and so on. While two logics are displayed in FIG. 8 it is to be appreciated that the logics can be combined and/or distributed into a greater and/or lesser number of logics.

In one example, the demodulating logic 610 inputs the signals from the demultiplexing logic 620 and converts them into binary k-tuples via IFCT. The IFCT output is a binary number that represents an amplitude value in the MASK constellation (see, for example, FIG. 15). The binary k-tuple is the data bits represented by the amplitude. The de-mapping can be implemented digitally by, for example, employing a look-up table. A data store stores the look-up table of M k-tuples. The binary amplitude value can be employed as an address to fetch a corresponding k-tuple that contains the desired data bits.

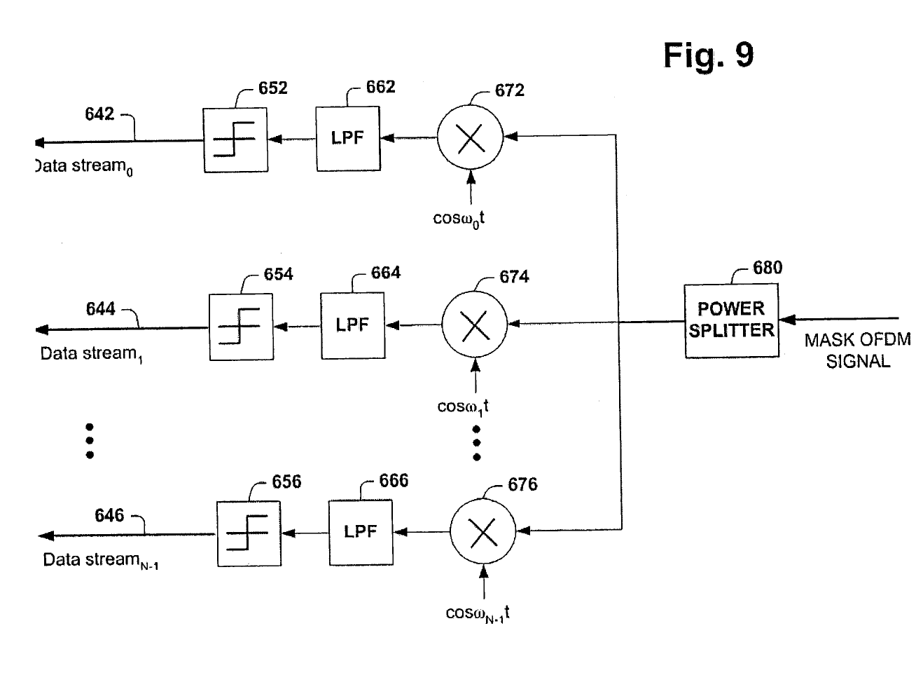

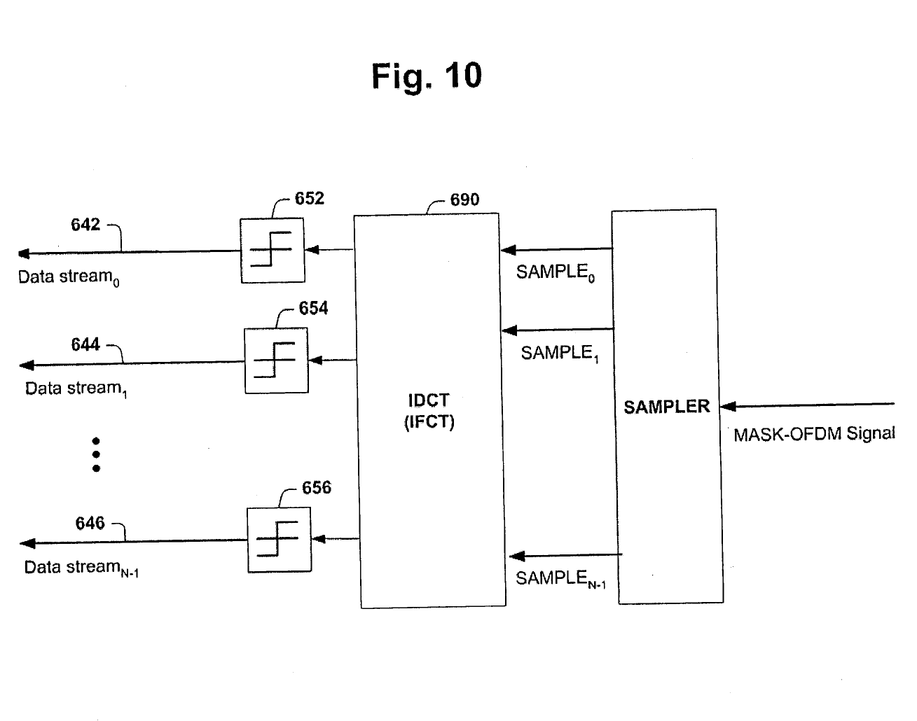

FIG. 9 illustrates an example MASK-OFDM system. A MASK-OFDM signal is received by a power splitter 680. A plurality of signals are split by the power splitter 680 and demodulated using demodulating components like the low pass filters 662 through 666, the threshold detectors 652 through 656, the multiipliers 672 through 676 and so on. A plurality of data streams (e.g., data streams 642 through data stream_{N-1} 646) are produced. While FIG. 9 illustrates the demultiplexing and demodulating broken out into separate logical and physical operations, FIG. 10 illustrates an integrated system.

FIG. 10 illustrates an example MASK-OFDM system that receives a MASK-OFDM signal, samples it, and implements an IDCT to demultiplex and demodulate the MASK-OFDM signal. Once again, a plurality of data streams (e.g., data streams 642 through data stream_{N-1} 646) are produced. The system may employ digital communication components like threshold detectors 652 through 656.

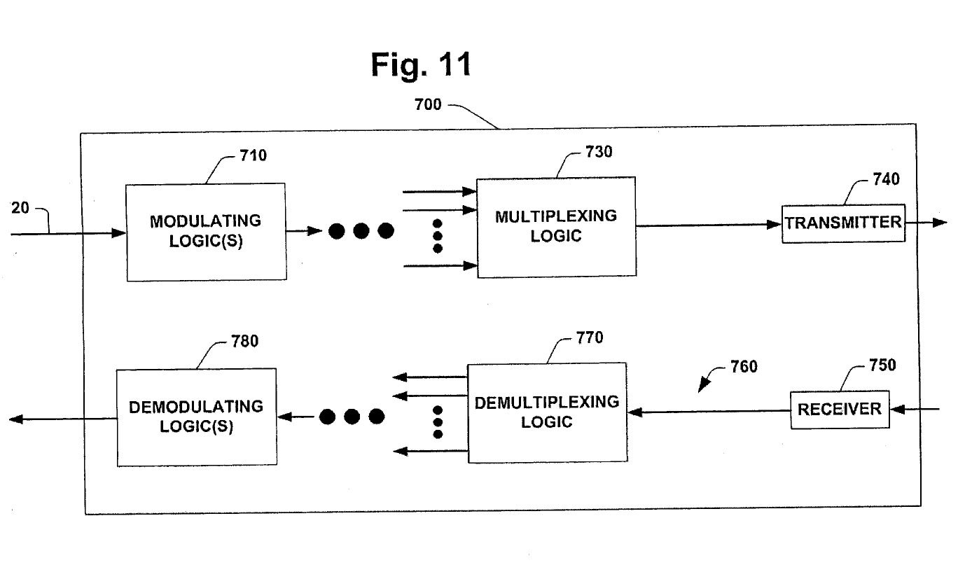

FIG. 11 illustrates portions of a modulator/demodulator 700 that employs MASK-OFDM. The modulator/demodulator 700 includes a modulating logic 710 that receives a first digital signal 720 to be transmitted. The logic 710 modulates the first digital signal 720 into M first amplitude shift keyed signals, M being an integer, using, for example, a digitally implemented DCT. The DCT may be implemented, for example, by an FCT.

The modulator/demodulator 700 also includes a multiplexing logic 730 that orthogonally frequency division multiplexes the first amplitude shift keyed signals into a first multiplexed signal. The modulator/demodulator 700 includes a transmitter 740 that transmits the first multiplexed signal. The first multiplexed signal may be transmitted, for example, on carrier frequencies that are separated by 1/(2T).

The modulator/demodulator 700 also includes a receiver 750 that receives a second orthogonally frequency division multiplexed signal comprising M second amplitude shift keyed signals. The receiver 750 provides the multiplexed signal 760 to a demultiplexing logic 770 that demultiplexes the second orthogonally frequency division multiplexed signal into second amplitude shift keyed signals. The modulator/demodulator 700 also includes a demodulating logic 780 that accepts the demultiplexed signals. The logic 780 then demodulates the second amplitude shift keyed signals into a second digital signal using, for example, a digitally implemented IDCT. The IDCT may be implemented, for example, by an IFCT. While four logics are displayed in FIG. 7 it is to be appreciated that the logics can be combined and/or distributed into a greater and/or lesser number of logics.

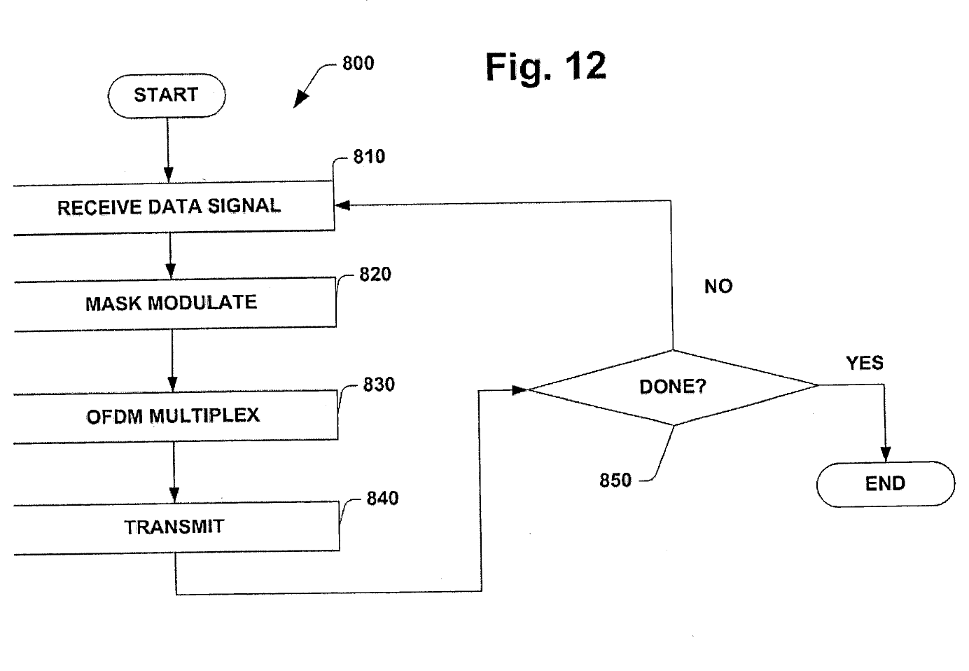

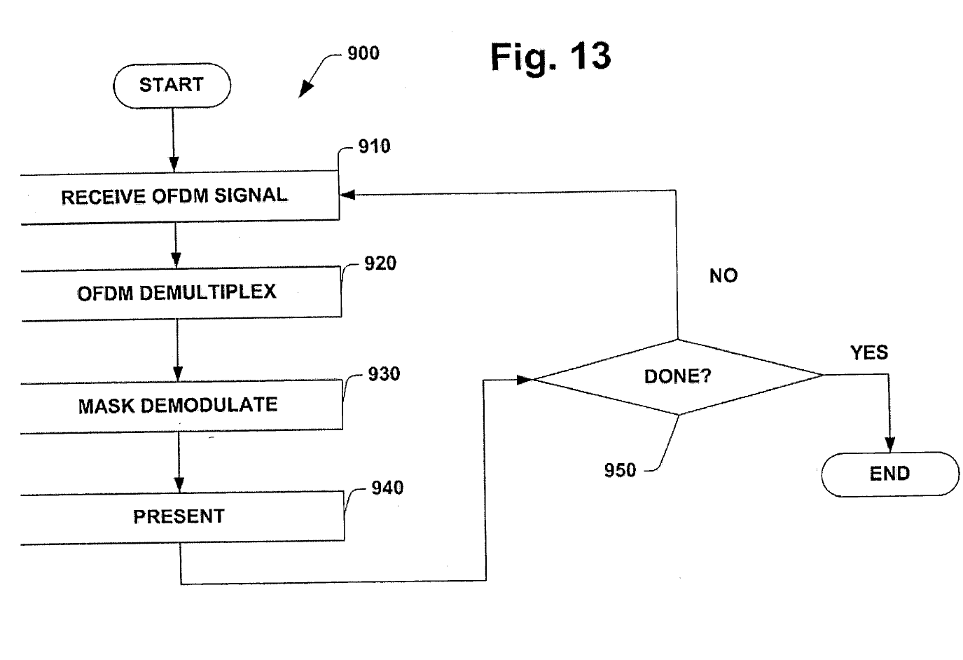

In view of the examples shown and described herein, example methodologies that are implemented will be better appreciated with reference to the flow diagrams of FIGS. 12 and 13. While for purposes of simplicity of explanation, the illustrated methodologies are shown and described as a series of blocks, it is to be appreciated that the methodologies are not limited by the order of the blocks, as some blocks can occur in different orders and/or concurrently with other blocks from that shown and described. Moreover, less than all the illustrated blocks may be required to implement an example methodology. Furthermore, additional and/or alternative methodologies can employ additional, not illustrated blocks. In one example, methodologies are implemented as computer executable instructions and/or operations, stored on computer readable media including, but not limited to an application specific integrated circuit (ASIC), a compact disc (CD), a digital versatile disk (DVD), a random access memory (RAM), a read only memory (ROM), a programmable read only memory (PROM), an electronically erasable programmable read only memory (EEPROM), a disk, a carrier wave, and a memory stick.

In the flow diagrams, rectangular blocks denote “processing blocks” that may be implemented, for example, in software. Similarly, the diamond shaped blocks denote “decision blocks” or “flow control blocks” that may also be implemented, for example, in software. Alternatively, and/or additionally, the processing and decision blocks can be implemented in functionally equivalent circuits like a digital signal processor (DSP), an application specific integrated circuit (ASIC), and the like.

A flow diagram does not depict syntax for any particular programming language, methodology, or style (e.g., procedural, object-oriented). Rather, a flow diagram illustrates functional information one skilled in the art may employ to program software, design circuits, and so on. It is to be appreciated that in some examples, program elements like temporary variables, routine loops, and so on are not shown.

FIG. 12 illustrates a method 800 for modulating and multiplexing data. The method 800 includes, at 810, receiving a data signal to transmit. At 820, the method 800 modulates the signal via M-ary amplitude shift keying into M amplitude shift keyed signals, M being an integer. At 830, the method 800 includes multiplexing the M amplitude shift keyed signals into a multiplexed signal via orthogonal frequency division multiplexing.

In one example, the method 800 can include transmitting the multiplexed signal as, for example, at 840. At 850, a determination can be made whether the method is done. If the determination at 850 is YES, then processing concludes, otherwise processing can return to 810.

In one example, the modulating performed at 820 employs a DCT. The DCT can be implemented digitally, for example, by an FCT. Computer readable and/or executable instructions for the method 800 and/or portions thereof can be stored on a computer readable medium.

FIG. 13 illustrates a method 900 for demultiplexing and demodulating data. The method 900 includes, at 910, receiving an orthogonal frequency division multiplexed M-ary amplitude shift keyed data signal. At 920, the method 900 includes demultiplexing the frequency multiplexed M-ary amplitude shift keyed data signal into M amplitude shift keyed signals. At 930, the method 900 includes demodulating the M amplitude shift keyed signals into a data signal. In one example, the method 900 can include, as for example at 940, presenting the data signal to a computer component. In one example, the demodulating of 930 is performed using an IDCT. The IDCT can be implemented digitally, for example, by an IFCT.

The method 900 can include a determination of whether the method is complete. If the determination at 950 is YES, then processing concludes, otherwise processing continues at 910. Computer readable and/or executable instructions for the method 900 and/or portions thereof can be stored on a compute readable medium.

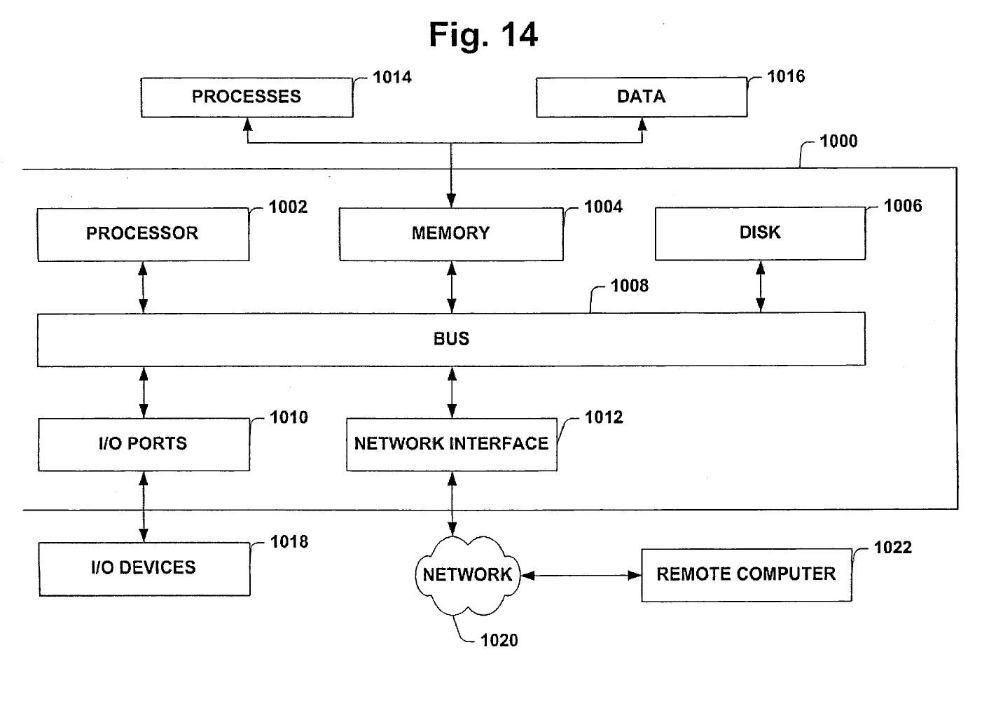

FIG. 14 illustrates a computer 1000 that includes a processor 1002, a memory 1004, a disk 1006, input/output ports 1010, and a network interface 1012 operably connected by a bus 1008. Executable components of the systems described herein may be located on a computer like computer 1000. Similarly, computer executable methods described herein may be performed on a computer like computer 1000. It is to be appreciated that other computers may also be employed with the systems and methods described herein. The processor 1002 can be a variety of various processors including dual microprocessor and other multi-processor architectures. The memory 1004 can include volatile memory and/or non-volatile memory. The non-volatile memory can include, but is not limited to, read only memory (ROM), programmable read only memory (PROM), electrically programmable read only memory (EPROM), electrically erasable programmable read only memory (EEPROM), and the like. Volatile memory can include, for example, random access memory (RAM), synchronous RAM (SRAM), dynamic RAM (DRAM), synchronous DRAM (SDRAM), double data rate SDRAM (DDR SDRAM), and direct RAM bus RAM (DRRAM). The disk 1006 can include, but is not limited to, devices like a magnetic disk drive, a floppy disk drive, a tape drive, a Zip drive, a flash memory card, and/or a memory stick. Furthermore, the disk 1006 can include optical drives like, compact disk ROM (CD-ROM), a CD recordable drive (CD-R drive), a CD rewriteable drive (CD-RW drive) and/or a digital versatile ROM drive (DVD ROM). The memory 1004 can store processes 1014 and/or data 1016, for example. The disk 1006 and/or memory 1004 can store an operating system that controls and allocates resources of the computer 1000.

The bus 1008 can be a single internal bus interconnect architecture and/or other bus architectures. The bus 1008 can be of a variety of types including, but not limited to, a memory bus or memory controller, a peripheral bus or external bus, and/or a local bus. The local bus can be of varieties including, but not limited to, an industrial standard architecture (ISA) bus, a microchannel architecture (MSA) bus, an extended ISA (EISA) bus, a peripheral component interconnect (PCI) bus, a universal serial (USB) bus, and a small computer systems interface (SCSI) bus.

The computer 1000 interacts with input/output devices 1018 via input/output ports 1010. Input/output devices 1018 can include, but are not limited to, a keyboard, a microphone, a pointing and selection device, cameras, video cards, displays, and the like. The input/output ports 1010 can include but are not limited to, serial ports, parallel ports, and USB ports.

The computer 1000 can operate in a network environment and thus is connected to a network 1020 by a network interface 1012. Through the network 1020, the computer 1000 may be logically connected to a remote computer 1022. The network 1020 includes, but is not limited to, local area networks (LAN), wide area networks (WAN), and other networks. The network interface 1012 can connect to local area network technologies including, but not limited to, fiber distributed data interface (FDDI), copper distributed data interface (CDDI), ethernet/IEEE 802.3, token ring/IEEE 802.5, and the like. Similarly, the network interface 1012 can connect to wide area network technologies including, but not limited to, point to point links, and circuit switching networks like integrated services digital networks (ISDN), packet switching networks, and digital subscriber lines (DSL).

FIG. 15 illustrates the constellation of 8ASK that is used in one example and the constellation of 64QAM that is used in the IEEE 802.11 standard. The 8ASK constellation is one-dimensional while the 64QAM is two-dimensional. This facilitates simplifying modulation, demodulation, synchronization and other operations in the MASK-OFDM.

The systems and methods described herein may be stored, for example, on a computer readable media. Media can include, but are not limited to, an application specific integrated circuit (ASIC), a compact disc (CD), a digital versatile disk (DVD), a random access memory (RAM), a read only memory (ROM), a programmable read only memory (PROM), a disk, a carrier wave, a memory stick, and the like.

What has been described above includes several examples. It is, of course, not possible to describe every conceivable combination of components or methodologies for purposes of describing the methods, systems, computer readable media and so on employed in coherent MASK-OFDM data communication systems and methods. However, one of ordinary skill in the art may recognize that further combinations and permutations are possible. Accordingly, this application is intended to embrace alterations, modifications, and variations that fall within the scope of the appended claims.

Furthermore, to the extent that the term “includes” is employed in the detailed description or the claims, it is intended to be inclusive in a manner similar to the term “comprising” as that term is interpreted when employed as a transitional word in a claim. Further still, to the extent that the term “or” is employed in the claims (e.g., A or B) it is intended to mean “A or B or both”. When the author intends to indicate “only A or B but not both”, then the author will employ the term “A or B but not both”. Thus, use of the term “or” herein is the inclusive, and not the exclusive, use. See BRYAN A. GARNER, A DICTIONARY OF MODERN LEGAL USAGE 624 (2d Ed. 1995).

What is claimed is:

1. A system, comprising:
a logic that modulates a received digital signal into M-ary amplitude shift keyed signals, M being an integer; and
a logic that orthogonally frequency division multiplexes the M amplitude shift keyed signals.

2. The system of claim 1 where the logic that modulates and the logic that multiplexes are one physical device.

3. The system of claim 1, comprising:
a transmitter that transmits the orthogonally frequency division multiplexed amplitude shift keyed signals.

4. The system of claim 3, where the transmitter is a wireless transmitter.

5. The system of claim 3, where the transmitter transmits over one or more wires.

6. The system of claim 1, where the logic that modulates and the logic that multiplexes employ a discrete cosine transform to modulate and multiplex.

7. The system of claim 6, where the discrete cosine transform is implemented digitally.

8. The system of claim 6, where the discrete cosine transform is implemented by a fast cosine transform.

9. The system of claim 3, where the transmitter transmits the multiplexed signals on subcarrier frequencies that are separated by 1/(2T).

10. A system, comprising:
means for MASK modulating a digital signal into a modulated digital signal;
means for OFDM multiplexing the modulated digital signal into a, multiplexed digital signal; and
a transmitter for transmitting the multiplexed digital signal.

11. A digital communication system, comprising:
an amplitude shift keying modulator that receives a digital signal to transmit and that amplitude shift keys the digital signal into M-ary amplitude shift keyed signals, M being an integer; and
an orthogonal frequency division multiplexer that orthogonally frequency division multiplexes the M-ary amplitude shift key modulated signals.

12. The system of claim 11, where the amplitude shift keying modulator and the orthogonal frequency division multiplexer are one physical device.

13. The system of claim 11, comprising:
a transmitter that transmits the orthogonally frequency division multiplexed M-ary amplitude shift keyed signals.

14. The system of claim 11, where the modulator and the multiplexer employ a discrete cosine transform to modulate and multiplex.

15. The system of claim 14, where the discrete cosine transform is implemented digitally.

16. The system of claim 14, where the discrete cosine transform is implemented by a fast cosine transform.

17. The system of claim 13, where the transmitter transmits the multiplexed signals on carrier frequencies that are separated by 1/(2T).

18. The system of claim 13, where the transmitter is a wireless transmitter.

19. The system of claim 13, where the transmitter transmits the multiplexed signals over one or more wires.

20. The system of claim 13, where the transmitter transmits the multiplexed signals over one or more fiber optic cables.

21. A system, comprising:
a logic that demultiplexes an orthogonally frequency division multiplexed MASK signal into M amplitude shift keyed signals; and
a logic that demodulates the M amplitude shift keyed signals into a digital signal.

22. The system of claim 21 where the logic that demultiplexes and the logic that demodulates are one physical device.

23. The system of claim 21, comprising:
a receiver that receives the orthogonally frequency division multiplexed MASK signal.

24. The system of claim 23, where the logic that demodulates and the logic that demultiplexes employ an inverse discrete cosine transform to demodulate and demultiplex.

25. The system of claim 24, where the inverse discrete cosine transform is implemented digitally.

26. The system of claim 24, where the inverse discrete cosine transform is implemented by an inverse fast cosine transform.

27. The system of claim 25, where the orthogonally frequency division multiplexed MASK signal is carried on subcarrier frequencies that are separated by 1/(2T).

28. A digital communication system, comprising:
an orthogonal frequency division demultiplexer that demultiplexes an orthogonally frequency division multiplexed signal into M-ary amplitude shift keying modulated signals, M being an integer; and
an amplitude shift keying demodulator that demodulates the M amplitude shift keying modulated signals.

29. The system of claim 28, where the demultiplexer and the demodulator are located in one physical device.

30. The system of claim 28, comprising:
a receiver that receives the orthogonally frequency division multiplexed signal.

31. The system of claim 28, where the demodulator and demultiplexer employ an inverse discrete cosine transform to demodulate or demultiplex.

32. The system of claim 31, where the inverse discrete cosine transform is implemented digitally.

33. The system of claim 31, where the inverse discrete cosine transform is implemented by an inverse fast cosine transform.

34. The system of claim 30, where the orthogonally frequency division multiplexed signals are carried on subcarrier frequencies separated by l/(2T).

35. The system of claim 30, where the receiver receives orthogonally frequency division multiplexed wireless signals.

36. The system of claim 30, where the receiver receives the orthogonally frequency division multiplexed signal over one or more wires.

37. The system of claim 30, where the receiver receives the orthogonally frequency division multiplexed signal over one or more fiber optic cables.

38. A system, comprising:
a receiver for receiving an orthogonally frequency division multiplexed signal;
means for orthogonal frequency division demultiplexing the orthogonally frequency division multiplexed signal into M-ary amplitude shift keying modulated signals, M being an integer; and
means for amplitude shift keying demodulating the M amplitude shift keying modulated signals.

39. A method, comprising:
modulating a digital signal via M-ary amplitude shift keying into M-ary amplitude shift keyed signals, M being an integer; and
multiplexing the M amplitude shift keyed signals into a multiplexed signal via orthogonal frequency division multiplexing.

40. The method of claim 39, where the modulating includes performing a discrete cosine transform.

41. The method of claim 40, where the discrete cosine transform is implemented digitally.

42. The method of claim 40, where the discrete cosine transform is implemented by a fast cosine transform.

43. A computer readable medium storing computer executable instructions for the method of claim 39.

44. A method, comprising:
demultiplexing an orthogonally frequency division multiplexed MASK signal into M amplitude shift keying signals; and
demodulating the M amplitude shift keying signals into a digital signal.

45. The method of claim 44, where the demodulating and demultiplexing includes performing an inverse discrete cosine transform.

46. The method of claim 45, where the inverse discrete cosine transform is implemented digitally.

47. The method of claim 45, where the inverse discrete cosine transform is an inverse fast cosine transform.

48. A computer readable medium storing computer executable instructions for the method for claim 44.

49. A system, comprising:
a logic that modulates a received first digital signal into first M-ary amplitude shift keyed signals, M being an integer;
a logic that orthogonally frequency division multiplexes the first M-ary amplitude shift keyed signals into a first multiplexed signal;
a transmitter that transmits the first multiplexed signal;
a receiver that receives a second orthogonally frequency division multiplexed signal comprising M-ary second amplitude shift keyed signals;
a logic that demultiplexes the second orthogonally frequency division multiplexed signal into second M-ary amplitude shift keyed signals; and
a logic that demodulates the second M-ary amplitude shift keyed signals into a second digital signal.

50. The system of claim 49, where the logic that modulates and the logic that multiplexes are located in one physical device and perform a fast cosine transform.

51. The system of claim 49, where the logic that demultiplexes and the logic that demodulates are located in one physical device and perform an inverse fast cosine transform.
